(19) United States
(12) Patent Application Publication
(10) Pub. No.: US 2015/0023617 A1
(43) Pub. Date: Jan. 22, 2015

(54) HYDROSTATIC BEARING

(71) Applicant: METAL INDUSTRIES RESEARCH AND DEVELOPMENT CENTRE, Kaohsiung (TW)

(72) Inventors: Kuo-Yu CHIEN, Meishan Township (TW); Ming-Yuan CHEN, Kaohsiung (TW)

(21) Appl. No.: 14/333,251

(22) Filed: Jul. 16, 2014

(30) Foreign Application Priority Data
Jul. 17, 2013 (TW) 102125543

(51) Int. Cl. F16C 32/06; F16C 29/02

(52) U.S. Cl. CPC F16C 32/0618; F16C 29/025; F16C 32/0681
USPC 384/12; 384/100

(57) ABSTRACT

A hydrostatic bearing adapted to be mated with a base includes a floating seat and a holder. The floating seat is made from a porous material and formed with a bearing surface that has a contour conforming to that of the base. The holder is coupled to the floating seat and cooperates with the floating seat to define an accommodating space for accommodating pressurized air. A pressurized air film is formed between the base and the bearing surface of the floating seat when the pressurized air discharges from the accommodating space through the floating seat so as to separate the floating seat from the base and so as to support the base.

### CROSS-REFERENCE TO RELATED APPLICATION

This application claims priority of Taiwanese Application No. 102125543, filed on Jul. 17, 2013.

### FIELD OF THE INVENTION

The invention relates to a bearing, more particularly to a hydrostatic bearing.

### BACKGROUND OF THE INVENTION

Air bearings, also known as aerodynamic bearings, are sliding bearings with air as a lubricant. Since air is smaller in viscosity than oil, thermotolerant, pollution-free, frictionless and low-maintenance, air bearings are able to provide high linear action accuracy and have almost no mechanical contact so that the minimum extent of wearing is ensured at a constant accuracy. Moreover, when air bearings are applied to high-speed applications, power loss and heat generation are both reduced at a minimum, and low friction and stable air flow will enhance power transmission and temperature control. Hence, air bearings are suitable for different application fields, such as high-speed machines, high-accuracy instruments and radioactive equipment and the service life of these machines, instruments or equipment are extendable.

Referring to FIG. 1, a conventional air bearing assembly disclosed in U.S. Pat. No. 7,722,256 B2 includes a lower portion 11, an upper portion 12 disposed above the lower portion 11, and a plurality of air conduits 13, each of which extends through a gap between the lower and upper portions 11, 12 and through the upper portion 12 and is in spatial communication with a corresponding one of air outlets 121 formed in the upper portion 12. Pressurized air is conveyed to the air outlets 121 through the air conduits 13 so as to form a pressurized air film on the upper portion 12 to support a substrate (not shown in FIG. 1). Thereby, the substrate and the upper portion 12 are spaced from each other by the pressurized air film and the substrate is able to move relative to the upper portion 12 in a low-friction and low-wearing manner.

However, for the conventional air bearing, formation of the air conduits 13 and mating arrangements among the air conduits 13 and the air outlets 121 of the upper portion 12 are complicated and take up space.

### SUMMARY OF THE INVENTION

Therefore, an object of the present invention is to provide a hydrostatic bearing that can overcome the aforesaid drawback of the prior art.

According to the present invention, a hydrostatic bearing adapted to be mated with a base includes a floating seat and a holder. The floating seat is made from a porous material and formed with a bearing surface that has a contour conforming to that of the base. The holder is coupled to the floating seat and cooperates with the floating seat to define an accommodating space for accommodating pressurized air. A pressurized air film is formed between the base and the bearing surface of the floating seat when the pressurized air discharges from the accommodating space through the floating seat so as to separate the floating seat from the base and so as to support the base.

### BRIEF DESCRIPTION OF THE DRAWINGS

Other features and advantages of the present invention will become apparent in the following detailed description of the embodiments with reference to the accompanying drawings, of which:

FIG. 1 is a sectional view for illustrating a conventional air bearing assembly disclosed in U.S. Pat. No. 7,722,256 B2;

FIG. 2 is a schematic view of the first embodiment of a hydrostatic bearing according to the present invention;

FIG. 3 is a schematic view of the second embodiment of a hydrostatic bearing according to the present invention;

FIG. 4 is a schematic view for illustrating another configuration of the second embodiment;

FIG. 5 is a schematic view of the third embodiment of a hydrostatic bearing according to the present invention;

FIG. 6 is a schematic view of the fourth embodiment of a hydrostatic bearing according to the present invention;

FIG. 7 is a schematic view of the fifth embodiment of a hydrostatic bearing according to the present invention;

FIG. 8 is a schematic view of the sixth embodiment of a hydrostatic bearing according to the present invention; and

FIG. 9 is a schematic view for illustrating another configuration of the sixth embodiment.

### DETAILED DESCRIPTION OP THE EMBODIMENTS

Before the present invention is described in greater detail with reference to the accompanying embodiments, it should be noted herein that like elements are denoted by the same reference numerals throughout the disclosure.

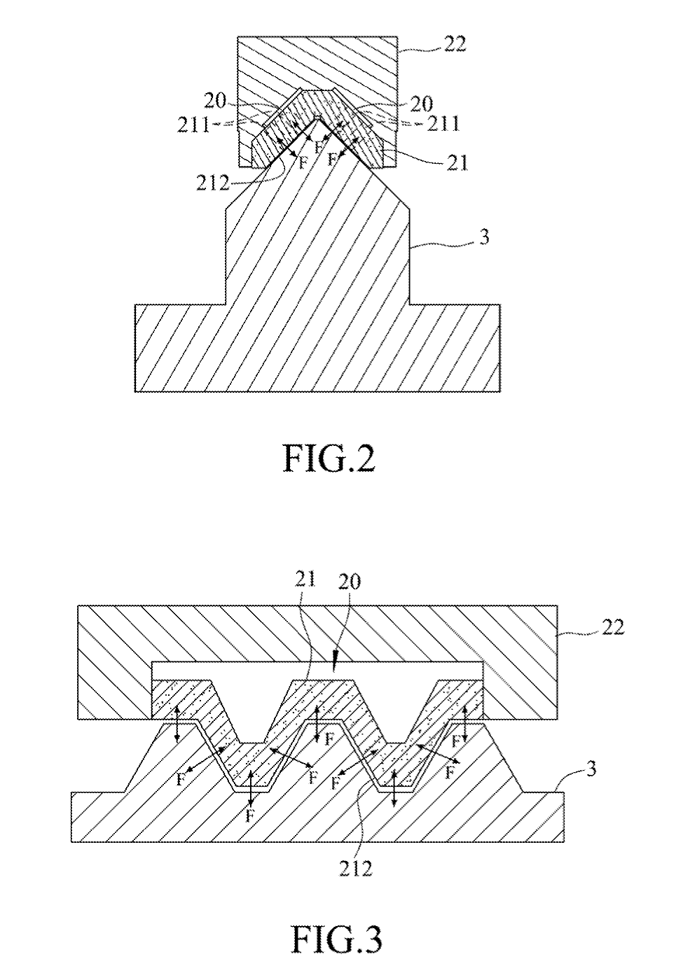

Referring to FIG. 2, the first embodiment of a hydrostatic bearing according to the present invention is shown to be mated with a base 3. The hydrostatic bearing includes a floating seat 21 and a holder 22. In this embodiment, the base 3 is configured as a slide rail that has an inverted-V shaped surface.

The floating seat 21 is made of a porous material so as to have a plurality of pores 211. The floating seat 21 is formed with a bearing surface 212 that has a contour conforming to that of the base 3. The bearing surface 212 may be a corrugated surface formed by a plurality of planar portions that are connected in series. In this embodiment, the bearing surface 212 is formed by two planar portions that cooperate with each other to form an included angle substantially of a right angle.

The holder 22 is coupled to the floating seat 21 and cooperates with the floating seat 21 to define an accommodating space 20. The accommodating space 20 is adapted to accommodate pressurized air. A pressurized air film is formed between the base 3 and the bearing surface 212 of the floating seat 21 when the pressurized air is discharged from the accommodating space 20 through the pores 211 of the floating seat 21. The pressurized air film thus formed is able to separate the base 3 from the floating seat 21 and to support the base 3. Besides, the pressurized air is conveyed into the accommodating space 20 through an air conduit (not shown). Conveyance of the pressurized air via the air conduit is not an essential feature of this invention and is known in the art, and thus details thereof are omitted herein.

In this embodiment, the accommodating space 20 is formed in the holder 22.

The pressurized air film formed between the base 3 and the bearing surface 212 of the floating seat 21 generates forces (F) perpendicular to the bearing surface 212 so that one component of each force (F) acts for separation of the base 3 from the floating seat 21. Thereby, the floating seat 21 is prevented from being in direct contact with the base 3 and the hydrostatic bearing is slidable relative to the base 3 with friction at a minimum.

In this embodiment, since the two planar portions of the bearing surface 212 are perpendicular to each other, the forces (F) acting on one of the two planar portions are perpendicular to those acting on the other of the two planar portions. Another component of each force (F) acts for retaining the floating seat 21 above the base 3. Hence, the forces (F) generated in a single hydrostatic bearing is able to provide supporting forces in different directions. Since the floating seat 21 stably floats above the base 3, an article, such as a substrate or a workplace (not shown) can be placed on the holder 22 to move relative to the base 3 through the hydrostatic bearing.

Referring to FIG. 3, the second embodiment of the hydrostatic bearing according to the present invention has a structure similar to that of the first embodiment except that the bearing surface 212 is in the form of a trapezoidal wave. The included angle between any two adjacent planar portions is an obtuse angle. The base 3 is configured to have a complementary surface mated with the bearing surface 212.

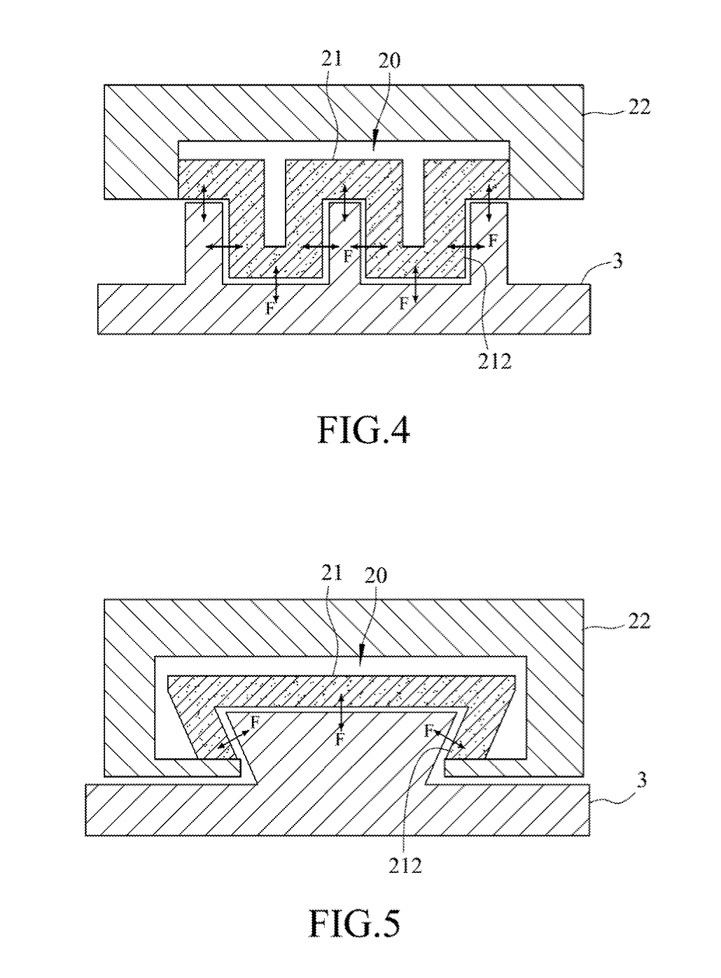

Referring to FIG. 4, another configuration of the second embodiment of the hydrostatic bearing according to the present invention has a structure similar to that of the first embodiment except that the bearing surface 212 is in the form of a square wave. The included angle between any two adjacent planar portions is a right angle. The base 3 is configured to have a complementary surface mated with the bearing surface 212.

Referring to FIG. 5, the third embodiment of the hydrostatic bearing according to the present invention has a structure similar to that of the first embodiment except that the bearing surface 212 is an inverted trapezoidal surface. The included angle between any two adjacent planar portions is an acute angle. The base 3 is a complementary surface mated with the bearing surface 212.

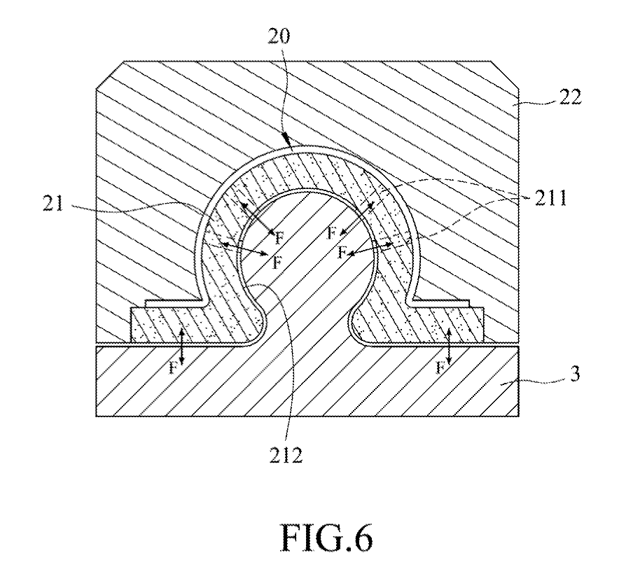

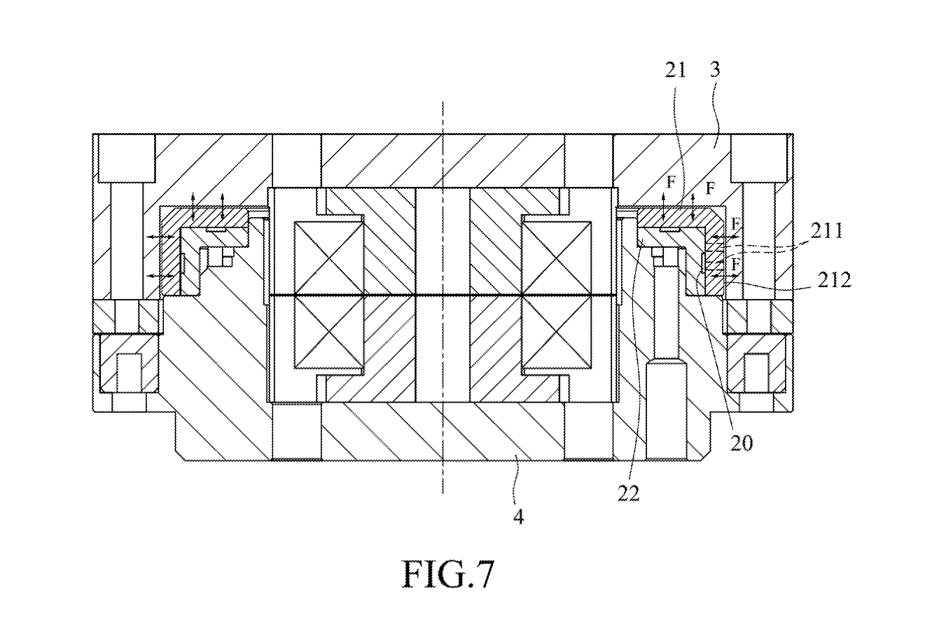

Referring to FIG. 6, the fourth embodiment of the hydrostatic bearing according to the present invention has a structure similar to that of the first embodiment except that the bearing surface 212 is an arc surface. The base 3 is configured to have a complementary surface meted with the bearing surface 212.

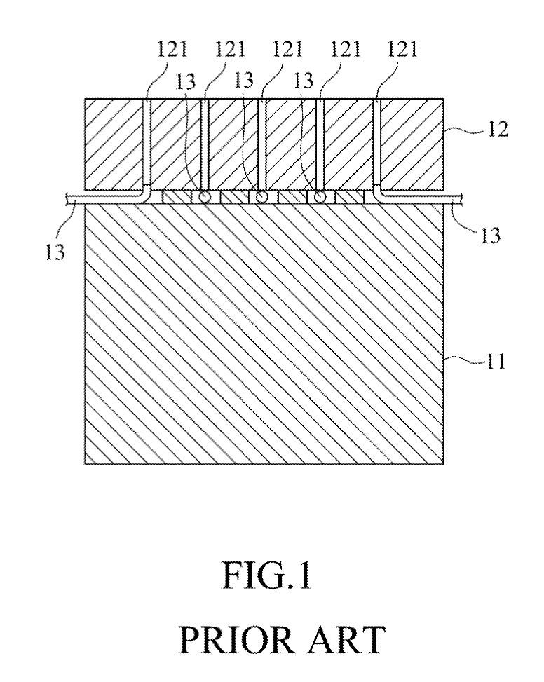

Referring to FIG. 1, the fifth embodiment of the hydrostatic bearing according to this invention is shown. In this embodiment, the hydrostatic bearing further includes a rotation member 4. The holder 22 is disposed on the rotation member 4 so as to be interposed between the rotation member 4 and the base 3. The floating seat 21 peripherally surrounds the holder 22. The bearing surf ace 212 is formed by two planar portions that cooperate with each other to form a right included angle therebetween. By means of the rotation member 4 and the pressurized air film formed between the bearing surface 212 and the base 3, the holder 22 is able to be driven by the rotation member 4 to be rotatable relative to the base 3.

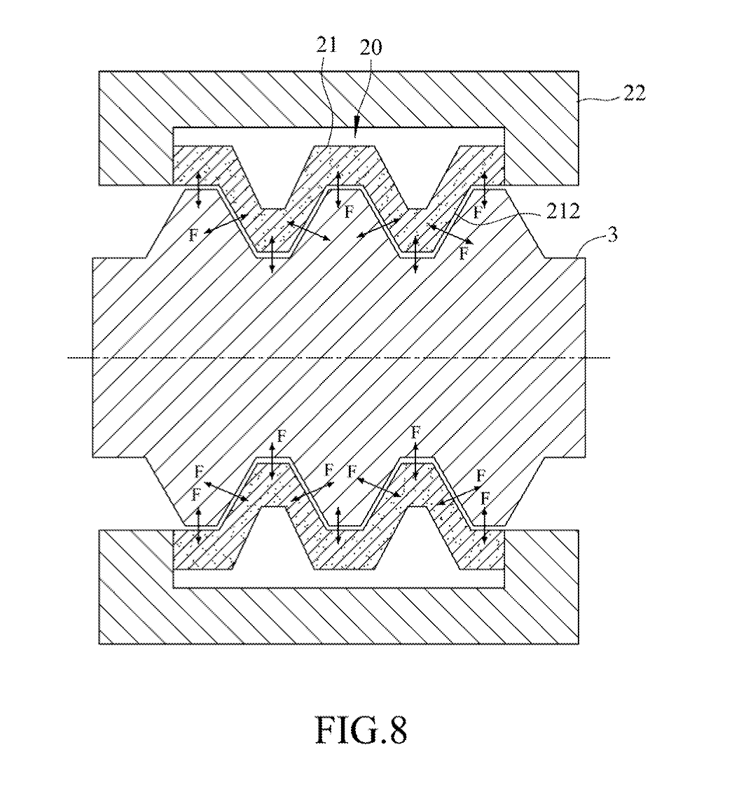

Referring to FIG. 8, the sixth embodiment of the hydrostatic bearing according to the present invention is shown. In this embodiment, the base 3 serves as a rotating shaft. The contour complementary relationship between the base 3 and the bearing surface 212 of the floating seat 21 is similar to that of the second embodiment of FIG. 3.

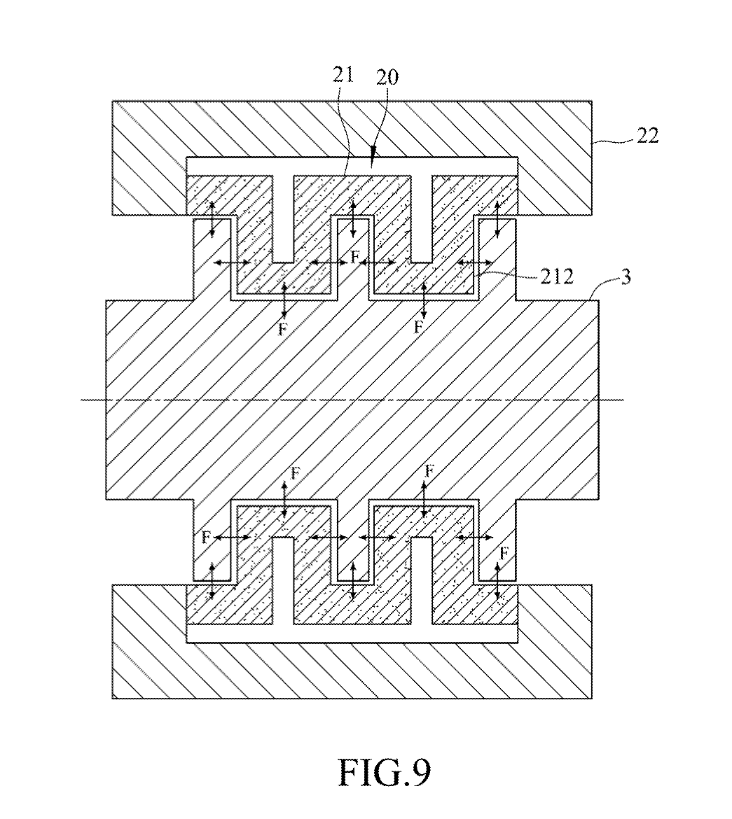

Referring to FIG. 9, another configuration of the sixth embodiment of the hydrostatic bearing according to the present invention has a structure similar to that shown in FIG. 8 except that the contour complementary relationship between the base 3 and the bearing surface 212 of the floating seat 21 is similar to that of the third embodiment of FIG. 4.

In sum, by the structural arrangement of the hydrostatic bearing of this invention, the pressurized air film formed between the base 3 and the bearing surface 212 of the floating seat 21 generates forces (F) perpendicular to a corresponding segment of the bearing surface 212 so that one component of each of the forces (F) acts for separation of the base 3 from the floating seat 21. Thereby, the floating seat 21 is prevented from being in direct contact with the base 3 and the hydrostatic bearing is slidable relative to the base 3 with friction at a minimum. Besides, another component of each of the forces (F) acts for retaining the floating seat 21 above the base 3. Hence, the forces (F) generated in a single hydrostatic bearing is able to provide supporting forces in different directions. It is not necessary to arrange a plurality of air conduits in different directions to provide supporting forces in different directions as required by the conventional air bearings. Not only is production cost reduced but manufacture procedures can also be simplified.

While the present invention has been described in connection with some exemplary embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A hydrostatic bearing adapted to be mated with a base, said hydrostatic bearing comprising:
a floating seat made from a porous material and formed with a bearing surface that has a contour conforming to that of the base; and
a holder coupled to said floating seat and cooperating with said floating seat to define an accommodating space for accommodating pressurized air;
wherein a pressurized air film is formed between the base and said bearing surface of said floating seat when the pressurized air is discharged from said accommodating space through said floating seat so as to separate said floating seat from the base and so as to support the base.

2. The hydrostatic bearing of claim 1, wherein said accommodating space is formed in the holder.

3. The hydrostatic bearing of claim 1, wherein said bearing surface is a corrugated surface formed by a plurality of planar portions that are connected in series, any two adjacent ones of the planar portions cooperating with each other to form an included angle therebetween.

4. The hydrostatic bearing of claim 3, wherein the included angle is a right angle.

5. The hydrostatic bearing of claim 3, wherein the included angle is an obtuse angle.

6. The hydrostatic bearing of claim 3, wherein the included angle is an acute angle.

7. The hydrostatic bearing of claim 1, wherein said bearing surface is an arc surface.

8. The hydrostatic bearing of claim 1, wherein said bearing surface is an inverted trapezoidal surface.

9. The hydrostatic bearing of claim 1, further comprising a rotation member, said holder being disposed on said rotation member to be interposed between said rotation member and the base, said floating seat peripherally surrounding said holder, said bearing surface being formed by two planar portions that cooperate with each other to form a right included angle therebetween, wherein said holder is driven by said rotation member to be rotatable relative to the base.

10. The hydrostatic bearing of claim 1, wherein said holder is rotatable around the base that serves as a rotating shaft.

11. The hydrostatic bearing of claim 1, wherein said holder is slidable relative to the base that is configured as a sliding rail.
